(19) United States
(12) Patent Application Publication
(10) Pub. No.: US 2019/0390905 A1
(43) Pub. Date: Dec. 26, 2019

(54) Continuous-flow drying installation and method for drying workpieces

(71) Applicant: EISENMANN SE, Boblingen (DE)

(72) Inventor: Jonas Burkart, Stuttgart (DE)

(21) Appl. No.: 16/449,617

(22) Filed: Jun. 24, 2019

(30) Foreign Application Priority Data
Jun. 25, 2018 (DE) 10 2018 115 235.3

(51) Int. Cl. F26B 7/00; F26B 15/10; F26B 25/06

(52) U.S. Cl. CPC F26B 7/00; F26B 2210/12; F26B 25/06; F26B 15/10

(57) ABSTRACT

A continuous-flow drying installation for drying workpieces, in particular vehicle bodies, having a heating zone enclosed by a first housing, in which the workpieces can be heated to a temperature T1, and having a cooling zone enclosed by a second housing, in which the workpieces heated in the heating zone can be cooled to a temperature T2<T1. The cooling zone is arranged completely above the heating zone. The continuous-flow drying installation additionally has a conveying zone enclosed by a third housing, in which there is arranged a transfer unit with which the workpieces heated in the heating zone can be transferred from the heating zone to the cooling zone, and a separating device which separates the heating zone from the conveying zone in an at least substantially air-tight manner but allows the workpieces to pass.

### RELATED APPLICATIONS

The present application claims priority to German Application No. 10 2018 115 235.3 filed Jun. 25, 2018—the contents of which is fully incorporated herein by reference.

### BACKGROUND OF THE INVENTION

### 1. Field of the Invention

The invention relates to a continuous-flow drying installation and to a method for drying workpieces, in particular vehicle bodies.

### 2. Description of the Prior Art

Workpieces and other vehicle bodies are conventionally dried, after a coating process, in a continuous-flow drier. Such a continuous-flow drier has a heating zone in which the workpieces to be dried are warmed. During the warming of the workpieces, the coating cures. The heat input into the workpieces can be effected, for example, by means of radiation or warm air.

The drier further has a cooling zone, which is arranged after the heating zone in the conveying direction of the workpieces. The cooling zone reduces the temperature of the heated workpieces, so that the workpieces can be further processed directly after the drying process.

The cooling zone is generally arranged immediately next to the heating zone. By arranging the heating zone and the cooling zone in a plane, the workpieces are able to pass continuously through the zones of the continuous-flow drier. However, with such an arrangement, an exchange of air takes place between the heating zone and the cooling zone. The exchange of air and the different temperatures of the heating zone and the cooling zone result in the water vapor contained in the warm air condensing out in the cooling zone. Furthermore, the exchange of air leads to considerable heat losses from the heating zone.

Therefore, frequently arranged between the heating zone and the cooling zone is an airlock or other separating device, which reduces the exchange of air between the zones. The reduction in the exchange of air lowers the risk of condensate formation in the cooling zone and reduces the heat losses of the continuous-flow drier.

A disadvantage of the construction, in particular of the arrangement of the zones, of such continuous-flow driers is the large overall length of the installation consisting of the various zones. The space requirement of the continuous-flow drier is therefore high.

### SUMMARY OF THE INVENTION

Accordingly, an object of the invention is to provide a continuous-flow drying installation for drying workpieces, in which there is achieved a compact and space-saving arrangement of the cooling zone and the heating zone which can flexibly be introduced into existing building structures.

This object may be achieved by a continuous-flow drying installation for drying workpieces, in particular vehicle bodies, having:
a heating zone enclosed by a first housing, in which the workpieces can be heated to a temperature T1, and having
a cooling zone enclosed by a second housing, in which the workpieces heated in the heating zone can be cooled to a temperature T2<T1.

According to the invention, the cooling zone is arranged completely above the heating zone. In addition, the continuous-flow drying installation has according to the invention:
a conveying zone enclosed by a third housing, in which there is arranged a transfer unit with which the workpieces heated in the heating zone can be transferred from the heating zone to the cooling zone, and
a separating device which separates the heating zone from the conveying zone in an at least substantially air-tight manner but allows the workpieces to pass through.

Accordingly, the invention follows the principle of arranging the heating zone and the cooling zone in different planes, so that the cooling zone is arranged completely above the heating zone. The cooling zone can cover the heating zone completely or in part, but it can also be arranged completely offset relative to the heating zone in the longitudinal or transverse direction thereof. In particular, the cooling zone can be arranged directly over the heating zone, so that the housing of the heating zone and the housing of the cooling zone adjoin one another. A particularly space-saving construction and thus a particularly efficient use of space of the continuous-flow drying installation is thereby achieved.

However, it is also conceivable that the cooling zone is arranged over the heating zone in such a manner that the housing of the heating zone and the housing of the cooling zone are at a distance from one another, in order to allow sufficient access to the heating zone and to the cooling zone for maintenance purposes. That distance is preferably 1.9 meters to 2.3 meters.

The transfer unit arranged in the conveying zone bridges the different heights of the heating zone and the cooling zone. In addition, the conveying zone causes a smaller exchange of air between the heating zone and the cooling zone, since the conveying zone acts as a buffer zone between the heating zone and the cooling zone. The air flowing out of the drier and past the separating device is distributed in the conveying zone. The water vapor partial pressure of the warm air thereby falls. This has the result that condensation of the water vapor contained in the warm air in the cooling zone is inhibited.

Furthermore, the flow of the hot air is slowed by the spatial volume of the conveying zone and the flow deflections in the conveying zone. The volume flow rate of the warm air entering the cooling zone thus falls.

The transfer unit of the conveying zone can in particular be a chain or belt lifting station, but a scissors lift is also conceivable. The transfer unit is to be so designed that the vertical offset between the heating zone and the cooling zone can quickly be compensated for during operation, in order to achieve time-efficient operation of the continuous-flow drying installation.

Substantially air-tight separation is understood here as meaning that no or only a slight exchange of air takes place between the adjacent zones, provided there is not too great a pressure difference between the two zones. A lift gate or leaf gate, for example, can be used as the separating device. The air-tight separation is only interrupted when a workpiece passes through the gate. Even better air tightness is achieved by a lock having two gates. It is particularly advantageous, however, if the separating device is in the form of an air-curtain-generating device which comprises nozzles arranged in rows or in a matrix or a longitudinal nozzle. During operation, air is blown out of the nozzles, or out of the nozzle, under high pressure in order to generate an air curtain, that is to say a substantially closed surface perpendicular to the conveying direction of the workpieces. Two regions can thus be atmospherically separated from one another without having to use movable parts, such as gates. During operation, the workpieces are conveyed from one region into the other region and thereby pass through the air curtain. As well as air, other gas mixtures or a pure gas can also be ejected from the nozzle or nozzles.

In one exemplary embodiment, the continuous-flow drying installation additionally has a conveying device with the conveying direction F arranged in the heating zone and a conveying device with the conveying direction G arranged in the cooling zone for conveying the workpieces through the heating zone and the cooling zone. This makes it possible to achieve a continuous movement of the workpieces through the continuous-flow drying installation with a conveying speed which can be adjusted at the conveying device.

In particular, the conveying directions F and G can be directed in opposite directions. As a result, the cooling zone can be arranged immediately above the heating zone, which permits a particularly small overall length of the continuous-flow drying installation. When the the conveying directions F and G are directed in the same direction, the heating zone and the cooling zone must be arranged one behind the other in the conveying direction. This has the result that the continuous-flow drying installation can be integrated particularly well into linear manufacturing installations. However, arrangements in which the conveying directions F and G run not (anti-)parallel but at an angle to one another also come into consideration. Roller conveyors and chain conveyors especially come into consideration as conveying devices. Rail-based skid-less conveying devices are particularly advantageous in terms of the flexibility of the conveying speeds.

In one exemplary embodiment, the continuous-flow drying installation additionally has between the conveying zone and the cooling zone a second separating device, which separates the conveying zone from the cooling zone in an at least substantially air-tight manner but allows the workpieces to pass through. The second separating device reduces the already described exchange of air between the heating zone and the cooling zone further, whereby the risk of condensate formation in the cooling zone is reduced further.

In one exemplary embodiment, the continuous-flow drying installation additionally has arranged at the entry to the heating zone a third separating device, which separates the heating zone from surroundings of the continuous-flow drying installation in an at least substantially air-tight manner but allows the workpieces to pass through. The heat losses from the heating zone to the surroundings are thereby reduced. Furthermore, the separation that is thereby created between the heating zone and the surroundings prevents particles and impurities from the surroundings from entering the heating zone.

In one exemplary embodiment, the separating device is an air-curtain-generating device which is adapted to generate an air curtain during operation. The heating zone, the cooling zone and the conveying zone can thereby be atmospherically separated from one another without movable parts, such as gates, having to be used. The degree of separation is thereby high throughout the entire conveying operation, even while the workpieces are passing through the separating device.

In one exemplary embodiment, the continuous-flow drying installation additionally has an extraction device with which air can be extracted from the conveying zone. The air which can be extracted by means of the extraction device can be fed to at least one of the first or third air-curtain-generating device via in each case a feed line. The extraction device removes heat from the air which flows from the heating zone into the conveying zone. The volume flow of warm air flowing into the cooling zone, and thus the risk of condensate formation in the cooling zone, is thereby reduced.

Furthermore, the temperature in the conveying zone can be influenced and adjusted with the extraction device. For example, arranging the extraction device at the entry to the conveying zone reduces the temperature in the conveying zone. As a result, there is already increased cooling of the workpieces in the conveying zone, so that the length of the cooling zone can be shortened. Conversely, arranging the extraction device at the exit of the conveying zone has the result that a higher temperature prevails in the conveying zone, so that a lower portion of the conveying zone performs the function of the heating zone. The length of the heating zone can be shortened as a result.

A further advantage of the extraction device is that the requirements for the first and second separating devices in terms of atmospheric separation are lower. Thus, for example, the air pressure with which air is ejected from the nozzles of the air-curtain-generating device can be lowered.

It is particularly effective to arrange the extraction device at the exit of the conveying zone in the region of a flow deflector. The rising warm air is slowed in the region of the flow deflector and collects in the upper region of the housing of the conveying zone. A large part of the warm air can thus be extracted at a single extraction point.

The warm air flowing out of the heating zone is recovered by feeding the warm air extracted from the conveying zone to the air-curtain-generating device. Heat losses from the heating zone are thereby reduced and energy-efficient operation of the continuous-flow drying installation is achieved.

Alternatively, instead of the extraction device it is also possible to arrange a plurality of air curtains in a plane, which are each arranged turned by 90° relative to one another. A plurality of air curtains arranged immediately one behind the other is also conceivable, in order to achieve a high degree of separation and thus a low exchange of air between the heating zone and the cooling zone.

In one exemplary embodiment, the continuous-flow drying installation has a plurality of extraction devices, with which air can be extracted from the conveying zone, and a collecting channel, in which the air extracted from the conveying zone can be combined and from which the extracted air can be fed to at least one of the first or third air-curtain-generating device via in each case a feed line. A plurality of extraction devices, in contrast to a single extraction device, has the advantage that the air flowing out of the heating zone and past the first separating device is extracted particularly effectively.

Furthermore, the requirements for each individual extraction device can thereby be lowered and the overall size can be reduced, since the air volume flow extracted by the respective extraction device is smaller. Local low-pressure points caused by the the extraction device can thereby be avoided. Furthermore, the temperature distribution in the conveying zone can be influenced by the distributed arrangement of the plurality of extraction devices and by different extraction volume flows of the individual extraction devices. It is thus possible, for example, to generate regions with a higher temperature and regions with a lower temperature in the conveying zone.

The collecting channel especially has the advantage that a uniform temperature of the air which can be fed to the air-curtain-generating device is achieved. The heat of the air extracted at a warmer point of the conveying zone can thus be transmitted to colder extracted air. Cold spots in the heating zone caused by cold air being blown in can thereby be avoided.

In one exemplary embodiment, the in each case one feed line or the collecting channel has a conditioning unit with which the air fed at least to the first or third air-curtain-generating device can be conditioned. The conditioning unit purifies and/or dehumidifies and/or warms the air delivered by the air-curtain-generating devices, so that it is particularly clean and has low humidity. Furthermore, the air warmed by the conditioning unit contributes toward achieving the heating temperature T1 required in the heating zone. If the temperature of the air blown in by the air-curtain-generating devices is substantially below the temperature T1, this leads to undesirable heat losses and to cold regions in the heating zone.

In one exemplary embodiment, the continuous-flow drying installation has a fan which is adapted to convey air into the conveying zone in order to counteract the formation of a low pressure therein. Otherwise, a low pressure could form in the conveying zone as a result of the extraction of air from the conveying zone, which could lead to an increased inflow of hot air from the heating zone into the conveying zone. As a result of the air fed to the conveying region by means of the fan, the extracted air stream is equalized, so that a low pressure in the conveying zone, and thus an inflow of hot air from the heating zone, is avoided. The volume flow of the warm air flowing into the cooling zone is thereby likewise reduced.

Alternatively, a passive opening can be provided in the housing of the conveying zone. In the case of a low pressure in the conveying zone, air can flow through the opening from outside into the conveying zone, in order to equalize the low pressure in the conveying zone. The opening is to be dimensioned according to the required incoming air streams, so that sufficient incoming air is able to flow into the conveying zone.

In one exemplary embodiment, the continuous-flow drying installation has arranged between the heating zone and the conveying zone and/or between the conveying zone and the cooling zone a rapid removal unit, which removes the workpieces cyclically from the heating zone into the conveying zone and/or from the conveying zone into the cooling zone. The rapid removal unit can in particular comprise a roller conveyor which has a higher conveying speed than the conveying speed of the conveying devices of the heating zone and the cooling zone.

The conveying devices of the cooling zone and of the heating zone preferably convey the workpieces continuously through the respective zone. However, the transfer unit of the conveying zone only transfers the workpieces from the heating zone into the cooling zone cyclically. In order to be able to combine the different modes of operation of the conveying devices and the transfer unit, the workpiece is removed from the conveying device to the transfer unit with a speed which is higher than the speed of the conveying devices of the heating zone and the cooling zone. A gap is thus created between the removed workpiece and the following workpiece, which is still on the conveying device of the heating zone. The distance between the individual workpieces on the conveying device can thus be chosen to be small without the conveying device having to be stopped between the cycles of the transfer unit.

The reverse principle applies for the transfer from the conveying zone to the cooling zone. The gap which forms between the last workpiece transferred to the conveying device of the cooling zone and the following workpiece is closed by the rapid removal unit. As a result, the distance between the individual workpieces can be small, which permits a high total throughput and thus a high cost effectiveness of the installation.

The object may further be achieved by a method for drying workpieces, in particular vehicle bodies, having the following steps:
a) the workpieces are conveyed through a heating zone enclosed by a first housing, in which the workpieces are heated to a temperature T1;
b) the workpieces pass at an exit of the heating zone through a separating device and into a conveying zone enclosed by a third housing;
c) in the conveying zone, the workpieces heated in the heating zone are conveyed from the heating zone to a cooling zone arranged completely above the heating zone and enclosed by a second housing; and
d) the workpieces are conveyed through the cooling zone and are cooled in the cooling zone to a temperature T2<T1.

The advantages mentioned in relation to the continuous-flow drying installation and preferred forms described in connection therewith apply correspondingly to the method according to the invention.

According to another aspect of the invention which is currently not being claimed, a single conveying device can convey the workpieces through the heating zone, the conveying zone and the cooling zone. An S-conveyor is especially conceivable. The use of a single conveyor for conveying the workpieces through all the zones of the continuous-flow drying installation permits especially a continuous conveying operation through the entire continuous-flow drying installation and thus also a high conveying speed, without a cyclic transfer unit and rapid removal units being required.

Other advantages and aspects of the present invention will become apparent upon reading the following description of the drawings and detailed description of the invention.

### BRIEF DESCRIPTION OF THE DRAWINGS

Exemplary embodiments of the invention are described in greater detail hereinbelow with reference to the drawings, in which:

FIG. 1 shows a continuous-flow drying installation according to the invention for drying vehicle bodies in a lateral section;

FIG. 2 shows a vertical section along line II-II through the continuous-flow drying installation shown in FIG. 1;

FIG. 3 shows a continuous-flow drying installation according to the invention according to a second exemplary embodiment in a lateral section, in which the cooling zone is arranged directly above the heating zone;

FIG. 4 shows a continuous-flow drying installation according to the invention according to a third exemplary embodiment in a lateral section, in which two conveying zones are provided and the cooling zone extends in the longitudinal direction to the heating zone;

FIG. 5 shows a continuous-flow drying installation according to the invention according to a third exemplary embodiment in a lateral section, in which two conveying zones are provided and the cooling zone partially covers the heating zone.

### DESCRIPTION OF PREFERRED EXEMPLARY EMBODIMENTS

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

### 1. First Exemplary Embodiment

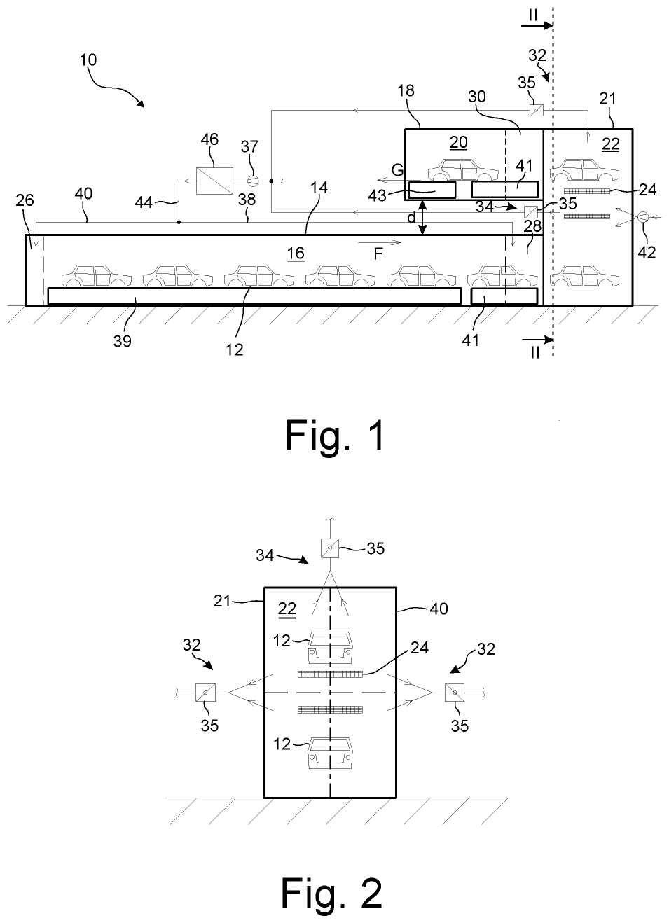

FIG. 1 shows a continuous-flow drying installation 10 according to the invention for drying workpieces 12. The continuous-flow drying installation 10 has a heating zone 16 enclosed by a first housing 14 and a cooling zone 20 enclosed by a second housing 18. The cooling zone 20 is arranged over the heating zone 16 with a distance d between the housing 18 of the cooling zone 20 and the housing 14 of the heating zone 16 and partially covers the heating zone 16. However, it is also conceivable that the cooling zone 20 covers the heating zone 16 completely. The distance d can in particular be between 1.9 m and 2.3 m, in order to permit sufficient access to the cooling zone 20 and the heating zone 16 for maintenance. The cooling zone 20 is shown shorter than the heating zone 16 in FIG. 1, but the cooling zone 20 and the heating zone 16 can be of the same length, or the cooling zone 20 can also be longer than the heating zone 16.

A conveying zone 22 enclosed by a third housing 21 is arranged after the heating zone 16 in the conveying direction F. In the conveying zone 22 there is arranged a transfer unit 24 which transfers the workpieces 12 from the level of the heating zone 16 to the level of the cooling zone 20.

At the entry into the heating zone 16 there is arranged a separating device 26, which separates the heating zone 16 from the surroundings of the continuous-flow drying position. Further separating devices 28, 30 are arranged at the entry and at the exit of the conveying zone 22. The separating devices 28, 30 prevent warm air from flowing out of the heating zone 16 into the cooling zone 20. The separating devices 26, 28, 30 comprise nozzles arranged in rows. During operation, air is blown out of the nozzles, or out of the nozzle, under high pressure in order to generate an air curtain, that is to say a substantially closed surface.

The continuous-flow drying installation 10 has extraction devices 32, 34 arranged at the housing 21 of the conveying zone 22. The extraction devices 32, 34 comprise regulating units 35, which regulate the extraction volume flow, and a common fan 37 arranged in the collecting line 44 for generating a low pressure. The regulating units 35 can be manually or electrically controlled valves. In the collecting line 44 there is additionally arranged a conditioning unit 46 with which the extracted air is purified and dehumidified. The conditioning unit 46 can additionally heat the extracted air. The conditioned extracted air can be fed to the separating devices 26, 28 via feed lines 38, 40. A fan 42 serves to convey fresh air into the conveying zone 22.

The workpieces 12 are conveyed by means of a conveying device 39 with a conveying direction F first through the separating device 26 at the entry of the heating zone 16 into the heating zone 16. There, the workpieces 12 are heated to a temperature T1, whereby the coatings of the workpieces 12 are cured. The workpieces 12 pass through a separating device 28 arranged at the exit of the heating zone 16 and thereby enter the conveying zone 22. The transfer unit 24 arranged in the conveying zone 22 bridges the different heights of the heating zone 16 and the cooling zone 20 by lifting the respective workpiece 22 from the entry of the conveying zone 22 to the exit of the conveying zone 22. A rapid removal unit 41 (not shown) removes the workpieces 12 from the conveying device of the heating zone 16 to the transfer unit 24.

The extraction devices 32, 34 extract the hot air flowing from the heating zone 16 and past the separating device 26, in order to reduce the condensation risk in the cooling zone 20. A low pressure is thereby generated in the conveying zone 22, whereby a pressure gradient is generated between the heating zone 16 and the conveying zone 22. This has the result that the warm air of the heating zone 16 flows into the conveying zone and into the cooling zone. In order to equalize the low pressure, the fan 42 conveys fresh air or ambient air (e.g. from a production hall) into the conveying zone 22.

The extracted warm air is used energy-efficiently in that the air is guided into a collecting channel 44 and is fed to the separating devices 26, 28. A conditioning unit 46 is provided for purifying, dehumidifying and warming the extracted air.

At the exit from the conveying zone 22, the respective workpiece 12 is conveyed by a conveying device 43 with a conveying direction G through the separating device 30 and thereby conveyed into the cooling zone 20. In the cooling zone 20, the temperature of the workpieces 12 is cooled to a temperature T2<T1, so that the workpieces 12 can be processed further after leaving the continuous-flow drying installation 10. A rapid removal unit 41 removes the workpieces 12 from the transfer unit 24 and deposits the workpieces 12 on the conveying device of the cooling zone 20.

FIG. 2 shows a cross-section of the conveying zone 22 shown in FIG. 1 along the section line II-II shown in FIG. 1. Three extraction devices 32, 34 extract air from the conveying zone 22. The two extraction devices 32 are arranged at the sides of the conveying zone 22, and the third extraction device 34 is arranged on the upper side of the conveying zone 22.

### 2. Second Exemplary Embodiment

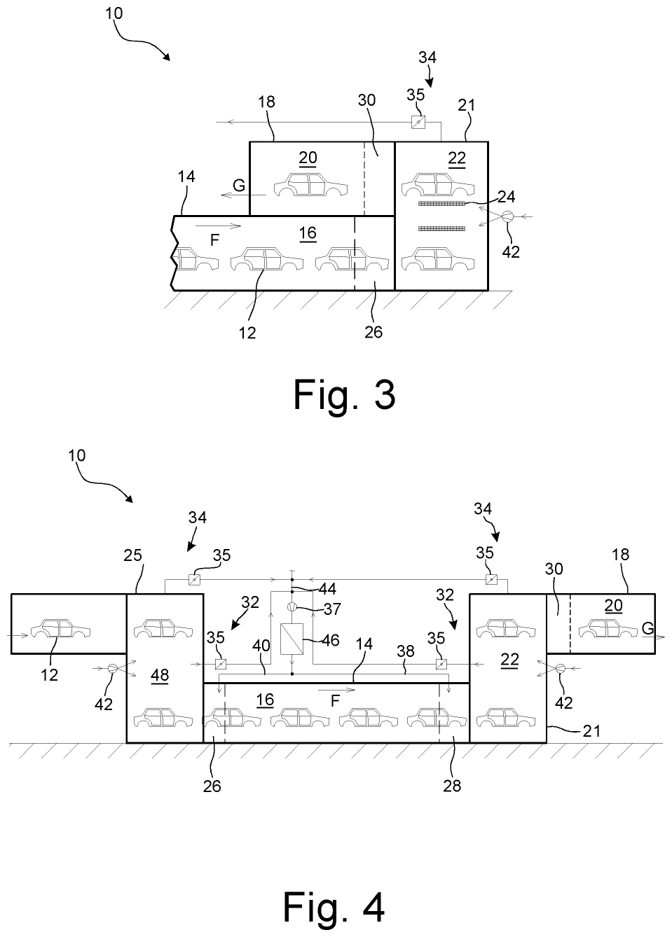

FIG. 3 shows the continuous-flow drying installation 10 substantially shown in FIG. 1 but, unlike in FIG. 1, the cooling zone 20 is arranged over the heating zone 16 without a distance, so that the housing 14 of the heating zone 16 and the housing 18 of the cooling zone 20 immediately adjoin one another. The overall height of the continuous-flow drying installation 10 is thereby reduced as compared with the continuous-flow drying installation 10 of FIG. 1.

### 3. Third Exemplary Embodiment

FIG. 4 shows the heating zone 16, cooling zone 20 and conveying zone 22 shown in FIG. 1. In addition, a further conveying zone 48 enclosed by a housing 25 is arranged before the heating zone 16 in the conveying direction F. A transfer unit 24 is likewise arranged in the further conveying zone 48. The workpieces 12 are fed to the further conveying zone 48 at a height which is the same as the height of the cooling zone 20. The feed of workpieces 12 into the continuous-flow drying installation 10 and the removal of the workpieces 12 from the continuous-flow drying installation 10 are thus located at one height. The different levels of the workpiece feed and the heating zone 16 are bridged by means of the transfer unit 24 by lowering the workpieces 12.

By means of such an arrangement of the heating zone 16 and the cooling zone 20, the floor area of the continuous-flow drying installation 10 that is used is small, while access to the heating zone 16 and the cooling zone 20 for maintenance purposes is facilitated as compared with the arrangements shown in FIGS. 1 and 3.

The arrangement of a further conveying zone 48 before the heating zone 16 has the advantage that a higher degree of separation of the continuous-flow drying installation 10 from the surroundings is effected, in order to reduce the penetration of particles and impurities into the heating zone 16 and in order to reduce heat losses from the heating zone 16.

### 4. Fourth Exemplary Embodiment

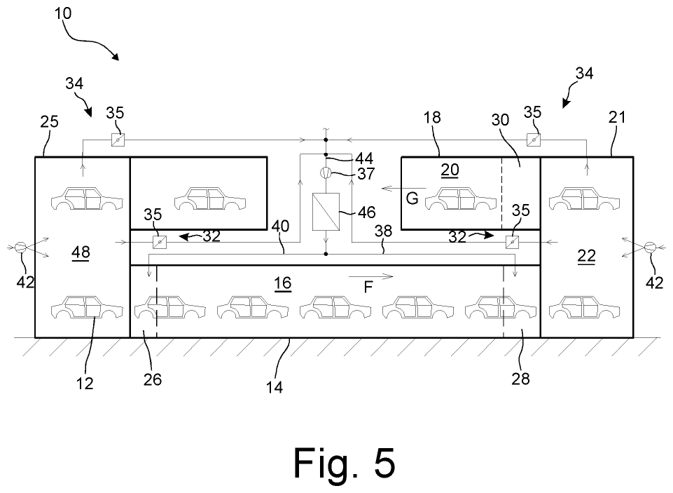

FIG. 5 shows the continuous-flow drying installation 10 having two conveying zones 22, 48 from FIG. 4. Unlike in FIG. 4, however, the feed direction of the workpieces 12 into the continuous-flow drying installation 10 is contrary to the conveying direction F. In addition, the conveying direction G of the workpieces 12 through the cooling zone 20 and the removal direction of the workpieces 12 from the continuous-flow drying installation 10 are likewise contrary to the conveying direction F.

The compactness of the continuous-flow drying installation 10 is thereby increased as compared with the continuous-flow drying installation 10 of FIG. 4.

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

1. A continuous-flow drying installation for drying workpieces, comprising:
a heating zone enclosed by a first housing, in which workpieces can be heated to a first temperature;
a cooling zone enclosed by a second housing, in which the workpieces heated in the heating zone can be cooled to a second temperature, the second temperature being less than the first temperature, wherein the cooling zone is arranged completely above the heating zone;
a conveying zone enclosed by a third housing, in which there is arranged a transfer unit with which the workpieces heated in the heating zone can be transferred from the heating zone to the cooling zone; and
a separating device which separates the heating zone from the cooling zone in an at least substantially air-tight manner but allows the workpieces to pass through.

2. The continuous-flow drying installation as claimed in claim 1, further comprising a first conveying device having a first conveying direction arranged in the heating zone and a second conveying device having a second conveying direction arranged in the cooling zone for conveying the workpieces through the heating zone and the cooling zone, respectively.

3. The continuous-flow drying installation as claimed in claim 1, further comprising a second separating device between the conveying zone and the cooling zone, wherein the second separating device separates the conveying zone from the cooling zone in an at least substantially air-tight manner but allows the workpieces to pass through.

4. The continuous-flow drying installation as claimed in claim 3, further comprising a third separating zone arranged at the entry to the heating zone, wherein the third separating device separates the heating zone from surroundings of the continuous-flow drying installation in an at least substantially air-tight manner but allows the workpieces to pass through.

5. The continuous-flow drying installation as claimed in claim 1, wherein the separating device is an air-curtain-generating device which is adapted to generate an air curtain during operation.

6. The continuous-flow drying installation as claimed in claim 5, further comprising an extraction device with which air can be extracted from the conveying zone, and wherein the air which can be extracted by means of the extraction device can be fed to at least one of a first or a third air-curtain-generating device via in each case a feed line.

7. The continuous-flow drying installation as claimed in claim 5, further comprising a plurality of extraction devices with which air can be extracted from the conveying zone, and a collecting channel in which the air extracted from the conveying zone can be combined and from which the extracted air can be fed to at least one of the first or the third air-curtain-generating device via in each case a feed line.

8. The continuous-flow drying installation as claimed in claim 7, wherein the in each case one feed line or the collecting channel has a conditioning unit with which the air fed at least to the first or the third air-curtain-generating device can be conditioned.

9. The continuous-flow drying installation as claimed in claim 5, further comprising a fan which is adapted to convey air into the conveying zone in order to counteract the formation of a low pressure therein.

10. The continuous-flow drying installation as claimed in claim 1, further comprising a rapid removal unit arranged between the heating zone and the conveying zone and/or between the conveying zone and the cooling zone, wherein the rapid removal unit removes the workpieces cyclically from the heating zone into the conveying zone and/or from the conveying zone into the cooling zone.

11. A method for drying workpieces comprising the following steps:
a) conveying workpieces through a heating zone enclosed by a first housing, in which the workpieces are heated to a first temperature;
b) passing the workpieces at an exit of the heating zone through a separating device and into a conveying zone enclosed by a third housing;
c) conveying the workpieces heated in the heating zone in the conveying zone from the heating zone to a cooling zone arranged completely above the heating zone and enclosed by a second housing; and
d) conveying the workpieces through the cooling zone and cooling the workpieces in the cooling zone to a second temperature, the second temperature being less than the first temperature.

12. The method as claimed in claim 11, wherein an extraction device extracts air from the conveying zone.

13. The method as claimed in claim 12, wherein the air extracted by means of the extraction device is fed to the separating device via a feed line.

14. The method as claimed in claim 11, wherein a plurality of extraction devices extract air from the conveying zone, and the extracted air is combined in a collecting channel and fed to the separating device via a feed line.

15. The method as claimed in claim 12, wherein a fan conveys air into the conveying zone in order to counteract the formation of a low pressure therein.
